(19) United States
(12) Patent Application Publication
(10) Pub. No.: US 2013/0263383 A1
(43) Pub. Date: Oct. 10, 2013

(54) VEHICLE SEAT COVER LEATHER HAVING EXCELLENT DURABILITY AND METHOD OF FABRICATING THE SAME

(71) Applicants: Gun Kang, Seoul (KR); Mi Jung Yun, Yongin (KR); Won-Ju Kim, Busan (KR); Sang-Chul Lee, Busan (KR); Eun-Chul Shin, Yangsan (KR)

(72) Inventors: Gun Kang, Seoul (KR); Mi Jung Yun, Yongin (KR); Won-Ju Kim, Busan (KR); Sang-Chul Lee, Busan (KR); Eun-Chul Shin, Yangsan (KR)

(73) Assignees: KOREA INSTITUTE OF FOOTWEAR & LEATHER TECHNOLOGY, Busan (KR); HYUNDAI MOTOR COMPANY, Seoul (KR)

(21) Appl. No.: 13/597,684

(22) Filed: Aug. 29, 2012

(30) Foreign Application Priority Data
Apr. 4, 2012 (KR) 10-2012-0034863

(51) Int. Cl. C14C 11/00

(52) U.S. Cl. 8/94.21

(57) ABSTRACT

Disclosed is a method of fabricating an automotive seat cover leather. The method includes a preparing process, a tanning process, a neutralizing process, a retanning process, an elastic material adding process, a dyeing/fatliquoring process, and a surface fixing process. After the leather has gone through the tanning process and neutralizing process, the retanning process adds a tanning agent to the leather. The elastic material adding process adds a silicon-based elastic material to induce elasticity in the retanned leather. The dyeing/fatliquoring process adds a dye to the leather in which the elastic material has been added and adds an anion fatliquoring agent to the leather to provide flexibility. The surface fixing process fixes the elastic material, dye, and fatliquoring agent on and in the leather.

### CROSS-REFERENCE TO RELATED APPLICATION

This application claims under 35 U.S.C. §119(a) the benefit of Korean Patent Application No. 10-2012-0034863 filed Apr. 4, 2012, the entire contents of which are incorporated herein by reference.

### BACKGROUND

(a) Technical Field

The present invention relates to a vehicle seat cover having excellent durability and a method of fabricating the same. More particularly, the present invention relates to a leather having improved tightness in its collagen fibers by selectively applying tanning agents that have excellent binding properties, and by adding an elastic material that can improve restitution force of the collagen fibers, improve tensile strength, and lessen the extension ratio to reduce outer appearance deformation.

(b) Background Art

Generally, the use of leather seat covers rather than fabric seat covers in vehicles has gradually increased because leather seat covers provide a softer texture and superior comfort as compared with fabric seat covers. Further, leather interiors are considered higher quality than fabric, and the number of consumers pursuing higher quality in automobile interior structures has also increased. However, when a driver or a passenger sits on a seat covered with a natural leather seat cover, the seat cover is wrinkled by external pressure and impact applied by the driver or passenger, thereby spoiling the appearance of the automotive seat. Once the wrinkles have been created, they are not easily removed but, rather, are maintained. Therefore, the use of natural leather would generally result in consumer dissatisfaction of the vehicle.

In addition, since natural leather is formed of animal collagen fibers, its physical properties are generally not uniform due to factors such as differences of breeding properties, differences of ages in the animals from which the leather originated, and differences in textures of respective regions from which the leather came from. Therefore, when manufacturing a natural leather seat cover, those portions/regions having inadequate properties are excluded, which increases production costs.

Therefore, in order to solve these limitations and meet the demands of consumers who wish for a high quality automobile interior material, automotive leather seat cover manufacturers have selectively applied a backing region having a relatively excellent physical property among a variety of regions of the natural leather, particularly to a seating portion of the seat cover. However, such seat covers still wrinkle.

In attempts to solve the above limitation, Korean Utility Model Publication No. 20-0371907 describes a method for inserting a shape retaining material having an elastic force between leather sheets. Korean Patent Application Publication No. 10-2007-0040139 describes a method for sewing a seat cover using a connecting member formed of an elastic material. However, by applying the connecting portions, these methods only focus on a structural problem of the automotive seat. Therefore, the functions can be easily lost. In particular, no processing technology of the leather that can reduce the wrinkling problem has been proposed.

In addition, Korean Laid-open Patent No. 10-2010-01378899 describes a method of fabricating salmon leather using a salmon skin that includes a preparing process, a tanning process, a dyeing/fatliquoring process for tanning treatment using a vegetable tanning agent such as a mimosa and the like and a silicon-based compound, and a finishing process. However, unlike skin from land animals, the salmon skin has a very-weak texture in an unprocessed skin state and, thus, it is limited because careful attention is required during the leather process.

A typical method of fabricating an automotive seat cover leather includes a preparing process, a tanning process, a dyeing process, and a painting process. The preparing process removes hairs, fat, soluble protein, and the like, which are unnecessary for producing the leather, from an untanned skin. The tanning process makes a stable fiber tissue by reacting a collagen protein with tanning agents such as chrome, aluminum, zirconium, aldehyde, vegetable, and the like. The dyeing process is one of the important steps which determines the product values. In the dyeing process, a variety of colors and flexibility are applied on the leather to meet consumer's wishes. When necessary, the painting process is performed in response to the propensity of the consumers.

This typical method typically takes into consideration the physical properties of the surface of the leather and uses a large amount of paining agents, resulting in a leather that is hardened, has bad ventilation and an artificial feel. In addition, this leather does not have enough tension-resistance against external pressure and impact applied when the driver or passenger takes a seat. Therefore, wrinkles are created on the surface of the natural leather seat cover.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described limitations of the prior art. The inventor(s) has researched to develop a method for preventing a wrinkle from being created on a surface of a vehicle seat cover leather by external pressure and impact applied when a driver or passenger takes a seat. It has been discovered through the research that physical properties of the leather are improved by selectively applying tanning agents that have excellent binding properties with the leather proteins, and by adding an elastic material to the leather.

Therefore, it is an object of the present invention to provide a vehicle seat cover which demonstrates improved durability, particularly by applying tanning agents and an elastic material.

In one aspect, the present invention provides a method of fabricating a vehicle seat cover leather including a preparing process, a tanning process, a neutralizing process, a retanning process, an elastic material adding process, a dyeing/fatliquoring process, and a surface fixing process. According to various embodiments, the retanning process adds a tanning agent to leather that has gone through the tanning process and the neutralizing process. According to various embodiments, the elastic material adding process adds a silicon-based elastic material to the retanned leather so as to provide elasticity. According to various embodiments, the dyeing/fatliquoring process adds a dye to the leather in which the elastic material is added and adds an anion fatliquoring agent to the leather to provide flexibility for the leather. According to various embodiments, the surface fixing process fixes the elastic material, dye, and fatliquoring agent on and in the leather.

According to another aspect, the present invention provides a vehicle seat cover leather fabricated by the above method. According to various embodiments, the leather is also particularly suitable for applications which require resistance and elasticity against pressure and force, such as furniture, bags, shoes, and the like. Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a flowchart illustrating a method of fabricating an automotive seat cover leather according to an exemplary embodiment of the present invention.

Reference numerals set forth in the Drawings includes reference to the following elements as further discussed below:
P100: retanning process
P200: elastic material adding process
P300: dyeing/fatliquoring process
P400: surface fixing process

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

While the following description relates specifically for an automobile seat cover leather, it is understood that it can also be applied to other vehicle seat covers, as well as other applications which may benefit from use of a leather having resistance and elasticity against pressure and force, such as furniture, bags, shoes, and the like.

The above and other features of the invention are discussed infra.

In the following description, only a portion required for understanding a method of fabricating an automotive seat cover leather that shows improvement in durability by using retanning agents and an elastic material according to the present invention will be described. The description of other portions can be in accordance with known methods and, thus, will be omitted herein so as to avoid distracting from a focal point of the present invention.

The term “Pelt” used herein has a meaning different from the term “leather” used herein. In particular, a pelt refers to leather in a state that has been subjected to a tanning process using a chrome tanning agent, which is different from a leather that is dyed. In addition, a chrome tanned leather refers a leather having heat-resistance and flexibility by converting animal protein into mineral protein using a chrome-containing material in a tanning process.

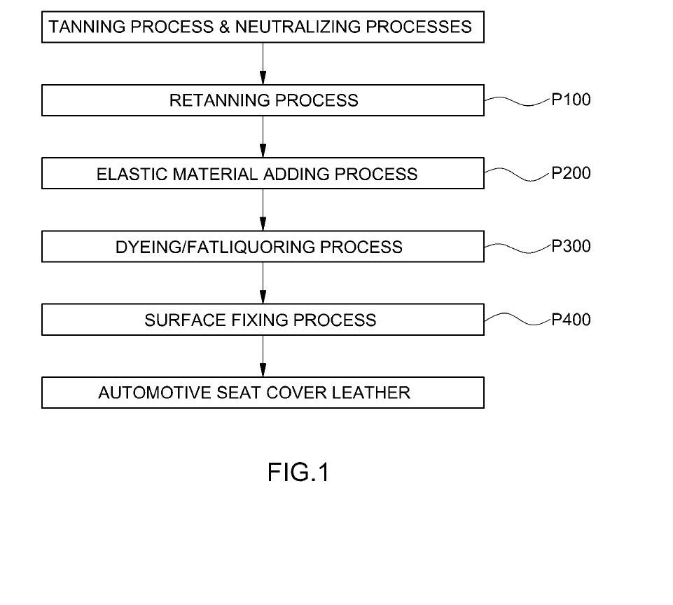

FIG. 1 is a flowchart illustrating a method of fabricating an automotive seat cover leather according to an exemplary embodiment of the present invention. An exemplary embodiment of the present invention will be described herein with reference to FIG. 1.

The present invention provides a method of fabricating an automotive seat cover leather including a preparing process, a tanning process, a neutralizing process, a retanning process, an elastic material adding process, a dyeing/fatliquoring process, and a surface fixing process.

In particular, according to the present invention, the retanning process is a process wherein a tanning agent is added to the leather that has gone through the tanning process and the neutralizing process.

Further, the elastic material adding process is a process subsequent to the retanning process wherein a silicon-based elastic material is added for inducing elasticity to the retanned leather.

Subsequent to the elastic material adding process, the dyeing/fatliquoring process is carried out, wherein a dye is added to the leather in which the elastic material has been added, and wherein an anion fatliquoring agent is added to the leather to provide flexibility for the leather.

Subsequent to the dyeing/fatliquoring process, the surface fixing process is carried out, wherein the elastic material, dye, and fatliquoring agent is fixed on and in the leather.

According to various embodiments, in the tanning process, a chrome-based tanning agent may be used to provided a pelt. The pelt then goes through the neutralizing process. In the subsequent retanning process, the tanning agent may be selected from the group consisting of a vegetable tanning agent such as mimosa and tara, a compound tanning agent such as an acryl-based syntan, a resin-based syntan, and a protein-based syntan, and a combination thereof.

According to various embodiments, the retanning process is carried out so as to improve the tightness and fullness of collagen fiber tissues of the leather after it has gone through the preparing process, tanning process, and neutralizing process. In an exemplary embodiment, in the retanning process is carried out by sequentially adding to a drum about 100 parts by weight of water, about 1-10 parts by weight of mimosa and tara, about 1-10 parts by weight of acryl-based syntan, about 1-10 parts by weight of resin-based syntan, and about 1-10 parts by weight of protein-based syntan, wherein the parts by weight are with respect to 100 parts by weight of leather. The drum is rotated at a suitable rotational speed, such as about 8-15 RPM, for a suitable period of time, such as about 60-120 minutes, while maintaining an internal temperature of the drum at a suitable temperature, such as about 35-45° C., so as to carry out the retanning process.

When the vegetable tanning agent and syntan are not sufficiently dissolved in the leather, the physical properties of the leather may be partly nonuniform. When the amount of the vegetable tanning agent and syntan is too small, they may not sufficiently permeate in and combine with the leather, and the desired tightness and fullness of the collagen fiber tissues may not be attained. On the contrary, when the amount of the vegetable tanning agent and syntan is too large, excess vegetable tanning agent and syntan are present which do not permeate and combine with the leather, leading to an increase in production costs and waste water.

The elastic material adding process P200 can be carried out by adding about 1-20 parts by weight of silicon-based elastic material, wherein the parts by weight are with respect to 100 parts by weight of leather, into the drum. The drum is rotated at a suitable rotational speed, such as about 8-15 RPM, for a suitable period of time, such as about 60-180 minutes, while maintaining a suitable internal temperature of the drum, such as about 40˜55° C.

According to various embodiments, the silicon-based elastic material may be selected from polydimethylsiloxane and cyclopentasiloxane.

When the elastic material is added in an amount of less than 1 part by weight, the permeation in and combination with the leather is not sufficient, and the desired elasticity may not be attained. When the elastic material is added more than 20 parts by weight, the excess agent that does not permeate in and combine with the leather may be fixed on the surface of the leather, which can spoil the appearance of the leather and result in adhesion problems in the subsequent painting process.

According to an exemplary embodiment, in order to provide the leather with flexibility, the dyeing/fatliquoring process P300 for adsorbing the dye and fatliquoring agent may be carried out by adding about 3-5 parts by weight of acid dye and 1-20 parts by weight of anion fatliquoring agent, wherein the parts by weight are based on 100 parts by weight of leather, into the drum. The drum is rotated at a suitable rotational speed, such as about of 8-15 RPM, for a suitable period of time, such as about 60-180 minutes, while maintaining a suitable internal temperature of the drum, such as about 40˜55° C. According to various embodiments, the acid dye may selected from a sulfonic acid-based dye and a carboxyl acid-based dye, and the anion fatliquoring agent may be selected from the group consisting of a sulfurous-based fatliquoring agent, a sulfonic acid-based fatliquoring agent, and a phosphate-based fatliquoring agent.

The surface fixing process P400 is carried out so as to re-adsorb the elastic material, dye, and fatliquoring agent. According to an exemplary embodiment, in the surface fixing process P400, about 0.5-3 parts by weight formic acid, wherein the parts by weight is with respect to 100 parts by weight of leather, is added to the drum to maintain the contents at about 2.0-4.0 pH. The drum may be rotated at a suitable rotational speed, such as about 8-15 RPM, for a suitable period of time, such as about 10-60 minutes, while maintaining a suitable internal temperature of the drum, such as about 40˜55° C., so that the elastic material, dye, and fatliquoring agent, which has not yet reacted, can be adsorbed onto the leather to provide elasticity and flexibility.

The present invention also provides an automotive seat cover leather that is fabricated in accordance with the above-described method. The leather has an improved tissue tightness. In addition, since the present invention provides an elastic material that is permeated and fixed in the leather to provide the elasticity, the tensile strength of the leather is increased while the extension ratio is reduced as compared with an existing automotive seat cover leather. Therefore, the leather demonstrates excellent resistance against wrinkles that are created when the driver or passenger sits.

In addition, in the fabrication of the automotive seat cover leather according to the present invention, the vegetable tanning agent, syntan, and elastic material may be used as additives. Further, in addition to and/or as alternates to these possible additives, any other tanning agents or equivalents thereof that have been used in the conventional art may be further used.

The following examples illustrate the invention and are not intended to limit the same. Particularly, it should be understood that the present invention is applicable to a general process for making a vehicle, particularly an automotive, seat cover leather product having excellent durability.

1. Automotive Seat Cover Leather Having Excellent Durability

### Example 1

In the preparing process of the method of fabricating the automotive seat cover leather having excellent durability, with respect to 100 parts by weight of leather, 5 parts by weight of lime was added under an alkali condition to remove hairs, fat, soluble proteins, etc., for 40 hours. In the tanning process, with respect to 100 parts by weight of leather, 6 parts by weight of chrome was permeated and fixed in the leather for 8 hours. In the neutralizing process, 6 parts by weight of sodium bicarbonate was used to neutralize to pH 5.5.

After the tanning process and neutralizing process, with respect to 100 parts by weight of leather, 100 parts by weight of water was added into a drum, after which, in the retanning process, with respect to 100 parts by weight of leather, 100 parts by weight of water, 5 parts by of weight mimosa, 5 parts by weight of acryl-based syntan, parts by weight of resin-based syntan, 5 parts by weight of protein-based syntan were sequentially added into the drum. Then, the drum was rotated at a rotational speed of 12 RPM for 120 minutes while maintaining the internal temperature of the drum 45° C. so that the agents were sufficiently dissolved in the water and thus the agents were sufficiently adsorbed in, combined with, and permeated in the leather.

After the above process, in the dyeing/fatliquoring process, with respect to 100 parts by weight of leather, 10 parts by weight of a silicon-based elastic material was added into the drum and the drum was rotated at a rotational speed of 12 RPM for 60 minutes while maintaining the internal temperature of the drum at 50° C. so that the elastic material was combined with the leather. Then, 3 parts by weight of acid dye in a solution phase was added into the drum and the drum was rotated at a speed of 12 RPM for 60 minutes while maintaining the internal temperature of the drum at 50° C. Then, 10 parts by weight of anion fatliquoring agent in a solution phase was added into the drum and the drum was rotated at a speed of 12 RPM for 120 minutes while maintaining the internal temperature of the drum at 50° C. so that the elastic material, dye, and fatliquoring agent, which were in the solution phase, combined with the leather. Then, 1 part by weight of formic acid as a fixing agent was diluted with water at a ratio of 1:10 and added into the drum, after which the drum was rotated at a speed of 12 RPM for 10 minutes while maintaining the internal temperature of the drum at 50° C. so that the elastic material, dye, and fatliquoring agent, which did not yet react, were further combined with the leather, thereby completing the automotive seat cover leather having elasticity and flexibility.

### Comparative Example 1

The processes were performed in a same manner as Example 1 except that, in the retanning process, chrome-based syntan was used instead of the vegetable tanning agent and syntan. All processes were performed under the same conditions as Example 1, thereby completing the automotive seat cover leather.

### Comparative Example 2

The processes were performed in a same manner as Example 1 except that, in the dyeing/fatliquoring process, the elastic material was excluded. All processes were performed under the same conditions as Example 1, thereby completing the automotive seat cover leather.

2. Evolution of Physical Property of Automotive Seat Covers

### Test Example 1

The evaluation of the physical properties of Example 1 and Comparative examples 1 and 2 are shown in Table 1.

As shown in Table 1, it was demonstrated that the tensile strength of Example 1, which is an automotive seat cover leather in accordance with the present invention, was better than that of Comparative examples 1 and 2 and the extension ratio of Example 1 was less than Comparative examples 1 and 2. In addition, it was also demonstrated that, when the extension property under a specific load and the load were removed, the remaining wrinkle ratio of Example 1 was less than Comparative examples 1 and 2.

TABLE 1

| | | Comparative | Comparative | |
|---|---|---|---|---|
| Test Items | Example 1 | Example 1 | Example 2 | Test Method |
| Tensile | 85.8 | 68.7 | 74.2 | MS 322-04 |
| Strength | | | | |
| (kgf/30 mm) | | | | |
| Extension | 52.4 | 72.4 | 81.2 | MS 322-04 |
| ratio(%) | | | | |
| Static load | 11.5 | 25.5 | 28.4 | MS 300-31 |
| elongation(%) | | | | |
| Remaining | 3.4 | 10.4 | 14.6 | MS 300-31 |
| wrinkle | | | | |
| ratio(%) | | | | |

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

According to the present invention, an automotive seat cover leather is provided having improved tightness of collagen fibers constituting the leather, having improved tensile strength, and having a reduced extension ratio. In particular, by selectively applying tanning agents that are excellent in binding property, tightness of the collagen fibers is achieved. Further, by adding an elastic material, tensile strength is improved and extension ratio is reduced, thus reducing outer appearance deformation of the leather, and improving restitution force of the collagen fibers. As such, the present automotive seat cover leather makes it possible to provide comfortable seating without deformation of the outer appearance of the seat.

In addition, by improving resistance against a tensile strength of an automotive natural seat cover material, the leather can be applied to a variety of leather products, particularly those which demand resistance and elasticity against pressure and impact, such as furniture, bags, shoes, and the like.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

1. A method of fabricating an automotive seat cover leather comprising a preparing process, a tanning process, a neutralizing process, a retanning process, an elastic material adding process, a dyeing/fatliquoring process, and a surface fixing process,
wherein in the retanning process, a tanning agent is added to the leather after the tanning process and the neutralizing process;
wherein in the elastic material adding process, a silicon-based elastic material is added for inducing elasticity to the retanned leather;
wherein in the dyeing/fatliquoring process, a dye is added to the leather in which the elastic material has been added, and an anion fatliquoring agent is further added to the leather to provide flexibility to the leather;
wherein the surface fixing process is carried out so as to fix the elastic material, dye, and fatliquoring agent on and in the leather; and
wherein in the retanning process, with respect to 100 parts by weight of leather and 100 parts by weight of water, about 1-10 parts by weight of mimosa, about 1-10 parts by weight of acryl-based syntan, about 1-10 parts by weight of resin-based syntan, about 1-10 parts by weight of protein-based syntan are sequentially added into a drum, and then the drum is rotated for about 60-120 minutes.

2. The method of claim 1, wherein the tanning agent is selected from the group consisting of mimosa, tara, an acryl-based syntan, a resin-based syntan, and a protein-based syntan, and combinations thereof.

3. (canceled)

4. The method of claim 1, wherein, in the elastic material adding process, about 1-20 parts by weight of an silicon-based elastic material, wherein parts by weight are with respect to 100 parts by weight of leather, is added into the drum and the drum is rotated for about 60-180 minutes.

5. The method of claim 4, wherein the silicon-based elastic material is polydimethylsiloxane or cyclopentasiloxane.

6. The method of claim 1, wherein, in the dyeing/fatliquoring process, about 3-5 parts by weight of acid dye and about 1-20 parts by weight anion fatliquoring agent, wherein parts by weight are with respect to 100 parts by weight of leather, are added into a drum in which the leather is added and the drum is rotated for about 60-180 minutes.

7. The method of claim 6, wherein the acid dye is a sulfonic acid-based dye or a carboxyl acid-based dye, and the anion fatliquoring agent is selected from the group consisting of a sulfurous-based fatliquoring agent, sulfonic acid-based fatliquoring agent, and a phosphate-based fatliquoring agent.

8. The method of claim 1, wherein, in the surface fixing process, about 0.5-3 parts by weight of formic acid, wherein parts by weight are with respect to 100 parts by weight of leather, is added into a drum in which the leather is added and the drum is rotated for about 10-60 minutes.

9. (canceled)
